(19) United States
(12) Patent Application Publication
(10) Pub. No.: US 2016/0328899 A1
(43) Pub. Date: Nov. 10, 2016

(54) EMBEDDED MAINBOARD FOR PARKING LOT CONTROL SYSTEM AND PARKING LOT CONTROL SYSTEM

(71) Applicant: XI'AN IRAIN IOT TECHNOLOGY SERVICE CO., LTD., Xi'an, Shaanxi (CN)

(72) Inventors: Linxiang Wang, Xi'an, Shaanxi (CN); Jiaoping Zhao, Xi'an, Shaanxi (CN); Yonghong Pan, Xi'an, Shaanxi (CN); Yuanying Lu, Xi'an, Shaanxi (CN)

(21) Appl. No.: 15/109,138

(22) PCT Filed: Apr. 28, 2014
(86) PCT No.: PCT/CN2014/076337

§ 371 Date: Jun. 30, 2016

(30) Foreign Application Priority Data
Jan. 15, 2014 (CN) 201410018506.5

(51) Int. Cl. G07C 9/00; G05B 15/02

(52) U.S. Cl. CPC G07C 9/00166; G05B 15/02

(57) ABSTRACT

An embedded mainboard for a parking lot control system, includes a control chip, an ethernet power supply unit, an image data processing unit for vehicle number identification, a network interface, an image input interface signally connected with the image data processing unit, a communication unit communicating with parking lot entrance-exit equipment and a control circuit controlling the parking lot entrance-exit equipment. The control chip controls the image data processing unit to identify license plates in images received from the image input interface, and integrates the image data processing unit in the embedded mainboard. Meanwhile, the network power supply unit charges to the embedded mainboard and other devices (such as an image capture device) connected with the embedded mainboard. Data communication with peripheral equipment is achieved by the communication unit, and operations of the peripheral equipment are controlled by the control circuit.

### FIELD OF THE DISCLOSURE

The present disclosure relates to the field of intelligent control technologies, and in particular, to an embedded mainboard for a parking lot control system and the parking lot control system.

### BACKGROUND OF THE DISCLOSURE

In the traditional parking lot system, desktop servers are used to realizing the image acquisition and the controlling of the barrier gate, in order to improve charging efficiency of vehicles coming in or out of the parking lot, a same vehicle can be charged commonly through gathering image information of the vehicles coming in or out and a solution of recognizing the gathered images to recognize license plates.

In the present technology, commonly, a license plate recognition unit can be located in an image acquisition device (such as in a license plate recognition device), the image acquisition device can directly recognize the gathered images, and send the recognized license plate number information to the desktop server communicatively connected with the image acquisition device, the desktop server charges according to preset charging parameters, however, as a price of the image acquisition device having the license plate recognition unit is too high, the cost of the parking lot control system is also high. Meanwhile, in the present technology, the image acquisition device and the desktop server both need to be powered to be charged, the power consumption is high, and the reliability is not enough.

### SUMMARY OF THE DISCLOSURE

The present disclosure aims to provide an embedded mainboard for a parking lot control system and the parking lot control system, aims to reduce power consumption and improve reliability as well as reducing a control cost of the parking lot.

The present disclosure provides an embedded mainboard for a parking lot system, which includes a control chip, an ethernet power supply unit, an image data processing unit for vehicle number recognition, a network interface connected with the control chip respectively, the embedded mainboard further includes an image input interface signally connected with the image data processing unit for vehicle number recognition, the image input interface is used for being signally connected with an image acquisition device, wherein:

the network interface is electrically connected with the ethernet power supply unit;

the image data processing unit for vehicle number recognition is used for dealing with vehicle images receiving by the image input interface to recognize license number;

the ethernet power supply unit is used for charging the embedded mainboard according to an amount of power received by the network interface.

Preferably, the embedded mainboard further includes a control circuit connected with the control chip, the control circuit is used for signally connecting with a barrier gate of the parking lot, the control chip is also used to control the control circuit to open or close a gate of the barrier gate of the parking lot, the gate is connected with the control circuit, and the control chip acquires a starting command of gathering images by receiving a signal from an image acquisition trigger ground sense controller.

Preferably, the embedded mainboard further includes a network interface signally connected with the control chip, the image input interface is connected with the control chip, the control chip is also used to control the network interface to send images received by the image input interface and data recognized and handled by the image data processing unit for vehicle number recognition to a client terminal.

Preferably, the embedded mainboard further includes a memory unit connected with the control chip, the image input interface is connected with the control chip, the control chip is also used to control the memory unit to store images received by the image input interface and data recognized and handled by the image data processing unit for vehicle number recognition.

Preferably, the image input interface is connected with the control chip, the embedded mainboard further includes an analog-to-digital conversion unit connected between the image input interface and the control chip, the numerical control chip controls the analog-to-digital conversion unit to convert an image analog signal inputted by the image input interface to a digital signal.

Preferably, the embedded mainboard further includes a first radio frequency identification unit signally connected with the control chip, the first radio frequency identification unit is used for recognizing received radio frequency signal.

Preferably, the embedded mainboard further includes a communication unit signally connected with the control chip, the communication unit is used for communicating with another texts at entrances and exits of the parking lot or a voice prompt device, control the device to output corresponding texts or voice signal.

The present disclosure further provides a parking lot control system, which includes an embedded mainboard, and an image acquisition device, a barrier gate of the parking lot and image acquisition trigger ground sense controller communicatively connected with the embedded mainboard, wherein the embedded mainboard includes a control chip, and an ethernet power supply unit, an image data processing unit for vehicle number recognition, a network interface connected with the control chip respectively, the embedded mainboard further includes an image input interface signally connected with the image data processing unit for vehicle number recognition, the image input interface is used for being signally connected with the image acquisition device, the network interface is electrically connected with the ethernet power supply unit; the image data processing unit for vehicle number recognition is used for data dealing with vehicle images receiving by the image input interface to recognize license numbers; the ethernet power supply unit is used for charging the embedded mainboard according to an amount of power received by the network interface.

Preferably, the embedded mainboard further includes a control circuit connected with the control chip, the control circuit is used for signally connecting with the barrier gate of the parking lot, the control chip is also used to control the control circuit to open or close a gate of the barrier gate of the parking lot, the gate is connected with the control circuit, and the control chip acquires a starting command of gathering images by receiving a signal from the image acquisition trigger ground sense controller.

Preferably, the embedded mainboard further includes a communication unit signally connected with the control chip, the image input interface is connected with the control chip, the control chip is also used to control the communication unit to send images received by the image input interface and data recognized and handled by the image data processing unit for vehicle number recognition to a client terminal.

Preferably, the embedded mainboard also includes a memory unit connected with the control chip, the image input interface is connected with the control chip, the control chip is also used to control the memory unit to store images received by the image input interface and data recognized and handled by the image data processing unit for vehicle number recognition.

Preferably, the image input interface is connected with the control chip, the embedded mainboard further includes an analog-to-digital conversion unit connected between the image input interface and the control chip, the numerical control chip controls the analog-to-digital conversion unit to convert an image analog signal inputted by the image input interface to a digital signal.

Preferably, the system further includes a power module communicatively connected with the embedded mainboard, the power module is used for charging the parking lot control system when the embedded mainboard cuts off a network connection.

Preferably, the system further includes a second radio frequency identification unit signally connected with the embedded mainboard, the second radio frequency identification unit is used for recognizing received radio frequency signal.

The embedded mainboard used in the parking lot control system and the parking lot control system are provided by the present disclosure, the embedded mainboard includes the control chip, and the ethernet power supply unit, the image data processing unit for vehicle number recognition, the network interface which are connected with the control chip respectively, further includes the image input interface signally connected with the image data processing unit for vehicle number recognition, the control chip controls the image data processing unit for vehicle number recognition to recognize the images received by the image input interface, and controls ethernet power supply unit to charge the embedded mainboard according to the amount of power received by the network interface, the image data processing unit for vehicle number recognition is integrated into the embedded mainboard, so that the cost of the image acquisition device can be reduced, meanwhile, the network interface is used for the embedded mainboard and other devices connected with the embedded mainboard (such as the image acquisition device is charged), a power consumption can be reduced under the condition of reducing cost.

### BRIEF DESCRIPTION OF THE DRAWINGS

FIG. 1 is a functional block diagram of the embedded mainboard for the parking lot control system according to a preferably embodiment of the present disclosure;

FIG. 2 is a functional block diagram of the parking lot control system according to a preferably embodiment of the present disclosure.

The realizing of the aim, functional characteristics, advantages of the present disclosure are further described in detail with reference to the accompanying drawings and embodiments.

### DETAILED DESCRIPTION OF THE EMBODIMENTS

Technical solutions of the present disclosure are further described in detail with reference to the accompanying drawings and embodiments. It is to be understood that, the described embodiments are only some exemplary embodiments of the present disclosure and the present disclosure is not limited to such embodiments.

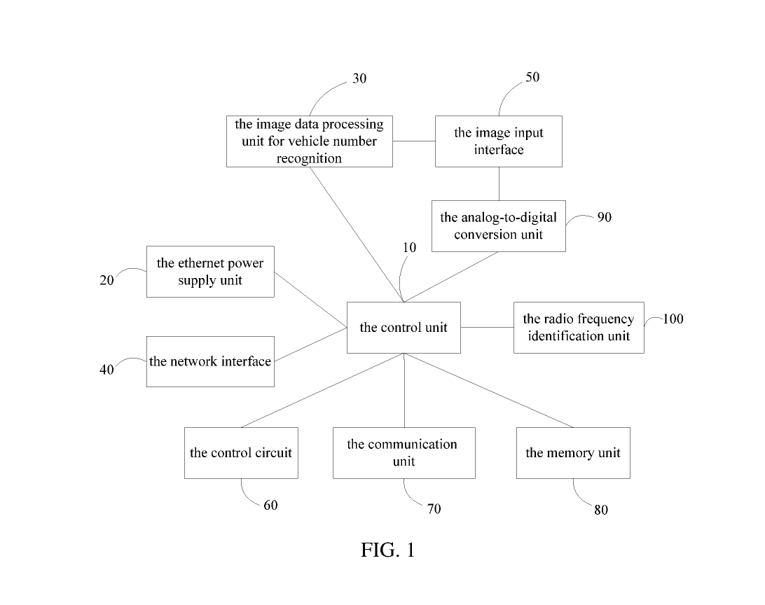

Referring to FIG. 1, FIG. 1 is a functional block diagram of the embedded mainboard for the parking lot control system according to a preferably embodiment.

The embodiment provides an embedded mainboard for a paring lot control system, which includes a control chip 10, and an ethernet power supply unit 20, an image data processing unit for vehicle number recognition 30, a network interface 40 which are connected with the control chip 10 respectively, the embedded mainboard further includes an image input interface 50 signally connected with the image data processing unit for vehicle number recognition 30, the image input interface 50 is used for being signally connected with an image acquisition device, wherein:

The network interface 40 is electrically connected with the ethernet power supply unit 20;

The image data processing unit for vehicle number recognition 30 is used for dealing with vehicle images receiving by the image input interface 50 to recognize characters on license plates;

The control unit 10 is used for controlling the ethernet power supply unit 20 to charge the embedded mainboard according to an amount of power received by the network interface 40.

When the image input interface 50 receives image information inputted by the image acquisition device (such as camera), the image input interface 50 sends the image information to the image data processing unit for vehicle number recognition 30 which can recognize characters on license plates, the image data processing unit for vehicle number recognition 30 can compare recognized license information with prestored numbers and texts and so on, and confirm the corresponding license number of the received image, send recognized license number information to a client terminal or save.

The principle of the ethernet power supply is that: a POE switch is connected with the network interface 40 of the embedded mainboard through a cable, first required power loss of the embedded mainboard connected with the it is evaluated, a power supply voltage of the embedded mainboard can be confirmed according to the evaluation result, during a start-up period of a preset time interval, the embedded mainboard is charged from a low voltage according to the confirmed power supply voltage, when the switch detects that the embedded mainboard is disconnected with the it, the switch stops charging the embedded mainboard. When the embedded mainboard receives an electric quantity inputted by switch through a network result, the ethernet power supply unit 20 charges the embedded mainboard according to the electric quantity received by the network interface 40.

The embodiment provides the embedded mainboard for the paring lot control system and the parking lot control system, the embedded mainboard includes the control chip 10, and the ethernet power supply unit 20, the image data processing unit for vehicle number recognition 30 and the network interface 40 which are connected with the control chip 10 respectively, the embedded mainboard further includes the image input interface 50 signally connected with the image data processing unit for vehicle number recognition 30, the control chip 10 controls the image data processing unit for vehicle number recognition 30 to deal with images received by the image input interface 50 to recognize characters on license plates, and controls the ethernet power supply unit 20 to charge the embedded mainboard according to the electric quantity received by the network interface 40, the image data processing unit for vehicle number recognition 30 is integrated into the embedded mainboard, so that the cost of the image acquisition device can be reduced, meanwhile, the network interface 40 can be used to charge the embedded mainboard and other devices connected with the embedded mainboard (such as the image acquisition device), a power consumption can be reduced under the condition of reducing cost.

Furthermore, the embedded mainboard also includes a control circuit 60 connected with the control chip 10, the control circuit 60 can be used to connect with signals of the barrier gate of the parking lot and an image acquisition trigger ground sense controller, the control chip 10 can also be used to control the control circuit 60 to open or close a gate of the barrier gate of the parking lot, the gate is connected with the control circuit 60, and the control chip 10 acquires a starting command of gathering images by receiving a signal from the image acquisition trigger ground sense controller.

In an exemplary embodiment, when the control chip 10 receives the license plate information received by an image recognition unit, the control chip 10 controls the opening of the gate of the barrier gate of the parking lot, the gate of the barrier gate is connected with the control chip 10, when the image data processing unit for vehicle number recognition 30 cannot recognize the license plate number, an alarm device is controlled to generate alarm information, and prompt a manager to enter the license information manually, and when a command of opening the gate of the barrier gate of the parking lot sent by the user through a trigger device is received, the trigger device can be keys, the control chip 10 sends an electric signal to the control circuit 60 connected with the control chip 10 to control the opening of the gate of the barrier gate of the parking lot; or when the license information entered by the manager manually is received, the control chip 10 directly sends the electric signal to the control circuit 60 to control the opening of the gate of the barrier gate of the parking lot according to the received electric signal; and when the vehicle leaves away from the gate, the control chip 10 controls the closing of the gate of the barrier gate of the parking lot, in the exemplary embodiment, the control chip 10 can send a corresponding electric signal to the control circuit 60 by changing a level state of an interface of the control circuit 60 connected with the control chip 10.

In another anamorphic embodiments, user can use an input device signally connected with the embedded mainboard to send opening command or closing command of the gate of the barrier gate of the parking lot to the control chip 10, the input device can be a display screen and keys, and user can also remotely send out opening command or closing command of the gate of the barrier gate of the parking lot to the control chip 10 through the network interface 40 formed on the embedded mainboard, so that the controlling of the barrier gate of the parking lot is much more convenient.

In the exemplary embodiment, the control circuit 60 of the gate of the barrier gate of the parking lot can be integrated on the embedded mainboard, and the control circuit 60 does not need to be set separately, the cost is saved.

Furthermore, the embedded mainboard also includes the network interface 40 signally connected with the control chip 10, the image input interface 50 is connected with the control chip 10, the control chip 10 is also used to control the network interface 40 to send the images received by the image input interface 50 and the data recognized and handled by the image data processing unit for vehicle number recognition 30 to the client terminal.

In the exemplary embodiment, the data recognized and handled by the image data processing unit for vehicle number recognition 30 includes the recognized license information, the embedded mainboard further includes the network interface 40, the network interface 40 can be a WIFI module, a Bluetooth module, an infrared module and a radio frequency module, and so on, can also be a multi-functional network interface 40 including the WIFI module, the Bluetooth module, the infrared module and the radio frequency module, and so on, locating the network interface 40 on the embedded mainboard, not only tested image and license information recognized by the image data processing unit for vehicle number recognition 30 can be sent to the client terminal, so that user can remotely browse the situation of recognizing the license plate, and supervise the recognizing of the license plate, and the remotely controlling of the parking lot can be achieved.

In the exemplary embodiment, a communication unit 70 can be used to communicate with another texts at entrances and exits of the parking lot and a voice prompt device, the device can be controlled to output corresponding texts or voice signal.

Furthermore, the embedded mainboard also includes a memory unit 80 connected with the control chip 10, the image input interface 50 is connected with the control chip 10, the control chip 10 can also be used to control the memory unit 80 to store images received by the image input interface 50 and the data recognized and handled by the image data processing unit for vehicle number recognition 30.

In the exemplary embodiment, the data recognized and handled by the image data processing unit for vehicle number recognition 30 includes the license information, the memory unit 80 can be located in the embedded mainboard to store the data recognized and handled by the image data processing unit for vehicle number recognition 30, so that user can invoke images and license information stored in the memory unit 80 at all times, and modify the license information.

User can send a blowing request of the license recognition information to the embedded mainboard through a human-computer interaction interface (such as a web-page or an APP interface) provided by the embedded mainboard, the embedded mainboard receives the blowing request of the license recognition information, sends the license recognition information to the terminal, the license recognition information includes stored images and the license plates corresponding to the images, if user finds mistakes existed in the license recognition during the blowing process, at this time a modification request of modifying the license recognition information can be sent to the embedded mainboard through controls formed on the human-computer interaction interface, when the control chip 10 formed in the embedded mainboard receives the modification request of modifying the license recognition information, controls the network interface 40 or sends down a modification interface of the license information to the terminal, user can modify the license information at the interface, when a modify completing command sent by the terminal is received, the control chip 10 controls the memory unit 80 adopts the modified license information to replace the original license information.

In another anamorphic embodiment, in order to save a memory space of the memory unit 80, the control chip 10 can control the memory unit 80 to delete the stored license recognition information regularly.

Furthermore, the image input interface 50 is connected with the control chip 10, the embedded mainboard also includes an analog-to-digital conversion unit 90 connected between the image input interface 50 and the control chip 10, the numerical control chip controls the analog-to-digital conversion unit 90 to convert an image analog signal inputted by the image input interface 50 to a digital signal.

In the exemplary embodiment, the analog image received by the image input interface 50 can be converted to the digital signal through the analog-to-digital conversion unit 90 to convenient the transmission of the received images.

Furthermore, the embedded mainboard further includes a radio frequency identification unit 100 signally connected with the control chip 10, the radio frequency identification unit 100 can be used to recognize received radio frequency signal.

In the exemplary embodiment, when a vehicle mounted with an electronic tag (such as a NFC tag) moves close to the first radio frequency identification unit 100 formed on the embedded mainboard, the electronic tag receives a microwave signal sent out by the first radio frequency identification unit 100, converts the microwave signal to a direct current to drive a circuit located inside the electric tag to work, meanwhile, sends the radio frequency signal to the first radio frequency identification unit 100 of the embedded mainboard, the radio frequency includes data information stored in the electric tag, the data information includes the license information of the vehicle, the first radio frequency identification unit 100 decodes the received radio frequency to obtain the privilege information of the entering and exiting vehicles.

Locating the first radio frequency identification unit 100 on the embedded mainboard can be used to recognize the vehicle mounted with the electric license plate and receive radio frequency card information, so that the recognition of the vehicle is more convenient.

In the exemplary embodiment, during the process of recognizing the vehicle number or radio frequency card representing the vehicle through the first radio frequency identification unit 100 located on the embedded mainboard, the first radio frequency identification unit 100 and the control chip 10 of the embedded mainboard can send an image acquisition command to the image acquisition device connected with them simultaneously through the image input interface 50, and the images received by the image input interface 50 and vehicle information recognized by the first radio frequency identification unit 100 can be associated with each other and stored through the control chip 10 and the first radio frequency identification unit 100, so that the veracity of the vehicle information recognized by the first radio frequency identification unit 100 can be ensured. The manager can check the stored vehicle information and images regularly or in real time, and compare to check for any identification errors, and if there are any, the recognized vehicle information can be modified.

In another anamorphic embodiments, the first radio frequency identification unit 100 and the image data processing unit for vehicle number recognition 30 can be adopted to recognize the license plate simultaneously, and compare achieved license information, when the license information achieved by the first radio frequency identification unit 100 is different from the license information achieved by the image data processing unit for vehicle number recognition 30, an alarming information can be produced, or the control chip 10 controls the communication unit 70 to play the license information and images to preset terminal to be validated manually, so that the accuracy of the license recognition can be ensured.

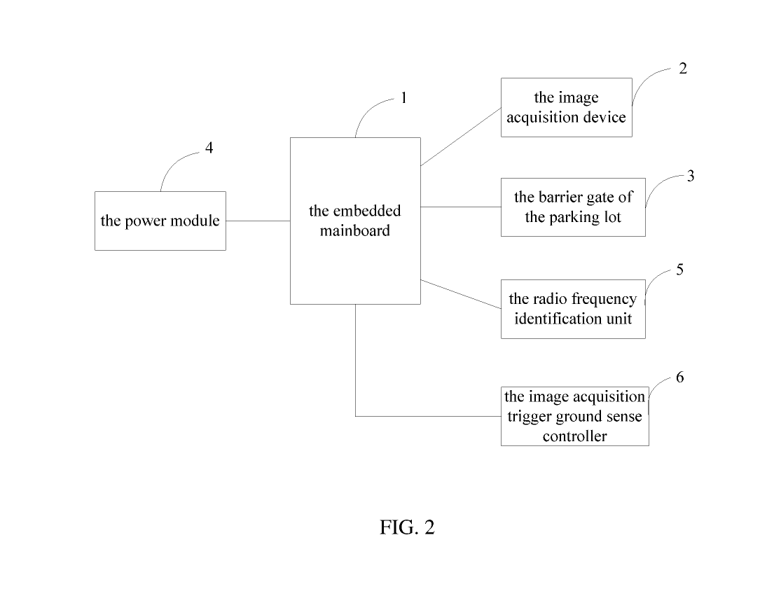

Referring to FIGS. 1-2, FIG. 2 is a functional block diagram of the parking lot control system according to a preferably embodiment of the present disclosure.

The present disclosure also provides a parking lot control system, which includes the embedded mainboard described the above embodiments, an image acquisition device 2 communicatively connected with the embedded mainboard 1 and a barrier gate of the parking lot 3, and an image acquisition trigger ground sense controller 6.

In an exemplary embodiment, the embedded mainboard 1 can control the image acquisition device 2 to gather images (a trigger signal of image acquisition can be sent out by the trigger ground sense controller 6), and control the opening and closing of the barrier gate of the parking lot. Such as, after the embedded mainboard 1 receives the trigger signal of image acquisition sent out by the trigger ground sense controller 6, the embedded mainboard 1 sends out the an image acquisition command to the image acquisition device 2 to control the image acquisition device 2 to start an operation of image acquisition, and handle and store the images gathered by the image acquisition device 2 (such as vehicle number recognition) and so on.

Furthermore, the system also includes a power module 4 communicatively connected with the embedded mainboard 1, the power module 4 is used for charging the parking lot control system when the embedded mainboard 1 cuts off the network connection.

Locating the power module 4 at the terminal can charge the embedded mainboard 1 and the image acquisition device 2 and other devices of the parking lot system when the embedded mainboard 1 is disconnected with the switch, or the switch gets out of order. Preferably, the power module 4 is a uninterruptible power source, when the parking lot control system is charged by the network interface 40 of the embedded mainboard 1, the uninterruptible power source is charged, after the charging is completed, the charging is automatically stopped, and when the embedded mainboard 1 cuts off the network connection, the embedded mainboard 1 and the image acquisition device 2 of the parking lot system is charged by the uninterruptible power source to ensure that the parking lot control system does not suddenly lose power which causes errors.

Furthermore, the system also includes a radio frequency identification unit 5 signally connected with the embedded mainboard 1, the second radio frequency identification unit 5 is used for recognizing received radio frequency signal.

In the exemplary embodiment, when the system is located at the second radio frequency identification unit 5 connected with the embedded mainboard 1, there is no need to locate the first radio frequency identification unit 100 in the front embedded mainboard, after the second radio frequency identification unit 5 recognizes the license number according to the received radio frequency information, the recognized vehicle information can be sent to the embedded mainboard 1 to be stored and sent to the preset terminal simultaneously.

The embodiments above are preferably embodiments of the present disclosure, and the present disclosure is not limited to such embodiments, equivalent structure conversion based on the specification and the drawing of the present disclosure, or directly or indirectly used in other related technical field, both similarly within the protection scope of the present disclosure.

1. An embedded mainboard for a parking lot control system, comprising: a control chip, an ethernet power supply unit, an image data processing unit for vehicle number recognition, a network interface connected with the control chip respectively, the embedded mainboard further comprising an image input interface signally connected with the image data processing unit for vehicle number recognition, the image input interface being used for being signally connected with an image acquisition device, wherein:
the network interface is electrically connected with the ethernet power supply unit;
the image data processing unit for vehicle number recognition is used for data dealing with vehicle images received by the image input interface to recognize characters on license plates;
the ethernet power supply unit is used for charging the embedded mainboard according to an amount of power received by the network interface.

2. The embedded mainboard according to claim 1, wherein the embedded mainboard further comprises a control circuit connected with the control chip, the control circuit is used for signally connecting with a barrier gate of the parking lot, the control chip is also used to control the control circuit to open or close a gate of the barrier gate of the parking lot, the gate is connected with the control circuit, and the control chip acquires a starting command of gathering images by receiving a signal from an image acquisition trigger ground sense controller.

3. The embedded mainboard according to claim 1, wherein the embedded mainboard further comprises a communication unit signally connected with the control chip, the image input interface is connected with the control chip, the control chip is also used to control the communication unit to send images received by the image input interface and data recognized and handled by the image data processing unit for vehicle number recognition to a client terminal.

4. The embedded mainboard according to claim 1, wherein the embedded mainboard also comprises a memory unit connected with the control chip, the image input interface is connected with the control chip, the control chip is also used to control the memory unit to storage images received by the image input interface and data recognized and handled by the image data processing unit for vehicle number recognition.

5. The embedded mainboard according to claim 1, wherein the image input interface is connected with the control chip, the embedded mainboard further comprise an analog-to-digital conversion unit connected between the image input interface and the control chip, the numerical control chip controls the analog-to-digital conversion unit to convert an image analog signal inputted by the image input interface to a digital signal.

6. The embedded mainboard according to claim 1, wherein the embedded mainboard further includes a first radio frequency identification unit signally connected with the control chip, the first radio frequency identification unit is used for recognizing received radio frequency signal.

7. A parking lot control system, comprising: an embedded mainboard, an image acquisition device, a barrier gate of the parking lot and image acquisition trigger ground sense controller communicatively connected with the embedded mainboard, wherein the embedded mainboard comprises a control chip, an ethernet power supply unit, an image data processing unit for vehicle number recognition, a network interface connected with the control chip respectively, the embedded mainboard further comprises an image input interface signally connected with the image data processing unit for vehicle number recognition, the image input interface is used for being signally connected with an image acquisition device, the network interface is electrically connected with the ethernet power supply unit; the image data processing unit for vehicle number recognition is used for data dealing with vehicle images receiving by the image input interface to recognize characters on license plates; the ethernet power supply unit is used for charging the embedded mainboard according to an amount of power received by the network interface.

8. The system according to claim 7, wherein the embedded mainboard further comprises a control circuit connected with the control chip, the control circuit is used for signally connecting with the barrier gate of the parking lot, the control chip is also used to control the control circuit to open or close a gate of the barrier gate of the parking lot, the gate is connected with the control circuit, and the control chip acquires a starting command of gathering images by receiving a signal of the image acquisition trigger ground sense controller.

9. An system according to claim 7, wherein the embedded mainboard further comprises a communication unit signally connected with the control chip, the image input interface is connected with the control chip, the control chip is also used to control the communication unit to send images received by the image input interface and data recognized and handled by the image data processing unit for vehicle number recognition to a client terminal.

10. The system according to claim 7, wherein the embedded mainboard also includes a memory unit connected with the control chip, the image input interface is connected with the control chip, the control chip is also used to control the memory unit to storage images received by the image input interface and data recognized and handled by the image data processing unit for vehicle number recognition.

11. The system according to claim 7, wherein the image input interface is connected with the control chip, the embedded mainboard further comprises an analog-to-digital conversion unit connected between the image input interface and the control chip, the numerical control chip controls the analog-to-digital conversion unit to convert an image analog signal inputted by the image input interface to a digital signal.

12. The system according to claim 7, the system further comprises a power module communicatively connected with the embedded mainboard, the power module is used for charging the parking lot control system when the embedded mainboard cuts off a network connection.

13. The system according to claim 7, the system further comprises a second radio frequency identification unit signally connected with the embedded mainboard, the second radio frequency identification unit is used for recognizing received radio frequency signal.
